(19) United States
(12) Patent Application Publication
(10) Pub. No.: US 2022/0261121 A1
(43) Pub. Date: Aug. 18, 2022

(54) METHOD OF PRESENTING INFORMATION ON A COMPUTER DISPLAY SCREEN

(71) Applicant: Jon C Ohrn, Chatham, NJ (US)

(72) Inventor: Jon C Ohrn, Chatham, NJ (US)

(21) Appl. No.: 17/449,014

(22) Filed: Sep. 27, 2021

Related U.S. Application Data
(60) Provisional application No. 63/083,653, filed on Sep. 25, 2020.

(51) Int. Cl. G06F 3/0482

(52) U.S. Cl. CPC G06F 3/0482; G06F 40/106

(57) ABSTRACT

An improved method of presenting information on a computer display screen. The information is presented on the screen in a Z and F pattern which corresponds to the natural eye-movement of a viewer. The improved method is implemented in a private marketplace for investors to take positions in commercial drugs without investing in the company's manufacturing or distribution of the product.

### CROSS-REFERENCE TO RELATED APPLICATION

This application claims priority to provisional application Ser. No. 63/083,653 filed on Sep. 25, 2020 and entitled “Online Display Interface for Taking Position In Dividual Commercial Drugs”, which is incorporated herein by reference.

### TECHNICAL FIELD

The present invention generally relates to the field of online display interfaces and more particularly, is directed to an improved method of presenting information on a computer display screen.

### BACKGROUND OF THE INVENTION

The Internet as it is known today has its origins in the 1960s. Computers of that day were primarily mainframe devices and the only way for information stored in one computer to be shared with another computer was for someone to copy the information onto a magnet tape or similar device and physically transfer the tape to the second computer for loading. Government researches needed a more efficient way to share information between computers and thus the first incarnation of the predecessor of what became the Internet was born. This first incarnation was soon replaced by the U.S. Defense Department's development of the improved and much more efficient ARPANET (Advanced Research Projects Agency Network).

Use of the ARPANET, however, was limited to academic and research organizations having contracts with the Defense Department.

The ARPANET was successful because the government controlled all of the networked computers and could force the use of a common communications protocols. While other computer networks existed, there was no standard way for those networks to communicate with each other.

This problem was overcome in 1983 when the Transfer Control Protocol/Internetwork Protocol (TCP/IP) was adopted as the standard transmission protocol for the ARPANET. TCP/IP allows computers on different networks to communicate with the each other. Thus, the Internet as it is known today came into fruition.

Since the emergence of the modern Internet, it has been used to facilitate virtually all types of private and commercial transactions. In addition to information sharing, the Internet plays a large role in commerce related to the buying and selling of goods and services.

Information sharing can simply be the transmission of electronic files from one computer to another with no required explanation or call-to-action. The end user of the information will know what to do with it, or at least that is the expectation.

In other instances, the information user might need to search through reams of information on, for example, a webserver in order to find the particular information that he or she wishes to have. Thus, the user interface for the webserver, often a webpage on a website, must present the information choices to the end user as conveniently as possible so that the user can find the required information as quickly as possible.

In the case of buying and selling goods and services, not only must the buying and selling choices be presented in the most efficient way possible, they must also be presented in the most user-friendly way possible so that the user does not become frustrated and terminate the process. The seller must also present the information in a way that calls for action on the part of the buyer.

While the Internet has become an indispensable tool of society, its effectiveness as a tool is limited by its ability to communicate with humans. Like most machines, this effectiveness is often a direct result of the Human-Machine Interface (HMI). An HMI is usually a display screen or dashboard and input devices such as a keyboard or switches that connects a person to a machine.

In case of the Internet, most human interactions occur through webpages on a website. There is a need in the art for an improved way to present information on a webpage, and receive input from the user, with respect to buying and selling transactions. The present invention addresses this need.

### BRIEF DESCRIPTION OF THE DRAWINGS

The novel features of the present invention are set out with particularity in the appended claims, but the invention will be understood more fully and clearly from the following detailed description of the invention as set forth in the accompanying drawings in which:

FIG. 1 illustrates the way in which the eyes scan a page using the F-Pattern;

FIG. 2 illustrates the way in which the eyes scan a page using the Z-Pattern;

FIG. 3 is a screen shot of the layout of a page listing commercial drugs that are available for positions accordance with the present invention;

FIG. 4 is a screen shot of the layout of a page for a particular commercial drug in accordance with the present invention;

FIG. 5 is a screen shot of the layout of an order dialog box for entering into a bespoke contract for a commercial drug of interest in accordance with the present invention; and

FIG. 6 is an enlarge view of the order dialog box as shown in FIG. 5.

### DESCRIPTION OF THE PREFERRED EMBODIMENT

An example embodiment of the present invention will now be described with reference to the accompanying drawings.

The present invention takes into account and builds on the visual hierarchy of a webpage and how the human eye responds to such hierarchy. Visual hierarchy is generally defined as the arrangement of graphic elements in a design based on their order of importance and visual weight.

Objects or elements in a design, such as a webpage, vary in “weight” relative to each other. For example, some objects appear larger in size and take up more space on a webpage than objects of lesser size. Some colors on a webpage are more dominate than other colors and appear heavier.

The location of elements on a webpage also contributes to the element's visual weight. Elements that are cast to the edges or bottom of a webpage usually are not considered as important as other elements and thus, have less visual weight.

Accordingly, the relative visual weight of objects on a webpage, such as menus, dropdown boxes, textboxes and labels, define the importance of those elements and communicate to the eye what to focus on and in what order.

All cultures read from the top down and most cultures tend to read from left to right. Moreover, most humans initially scan a page to determine whether they are interested enough to read it. Scanning patterns tend to take one of two forms, the F-Pattern or the Z-Pattern.

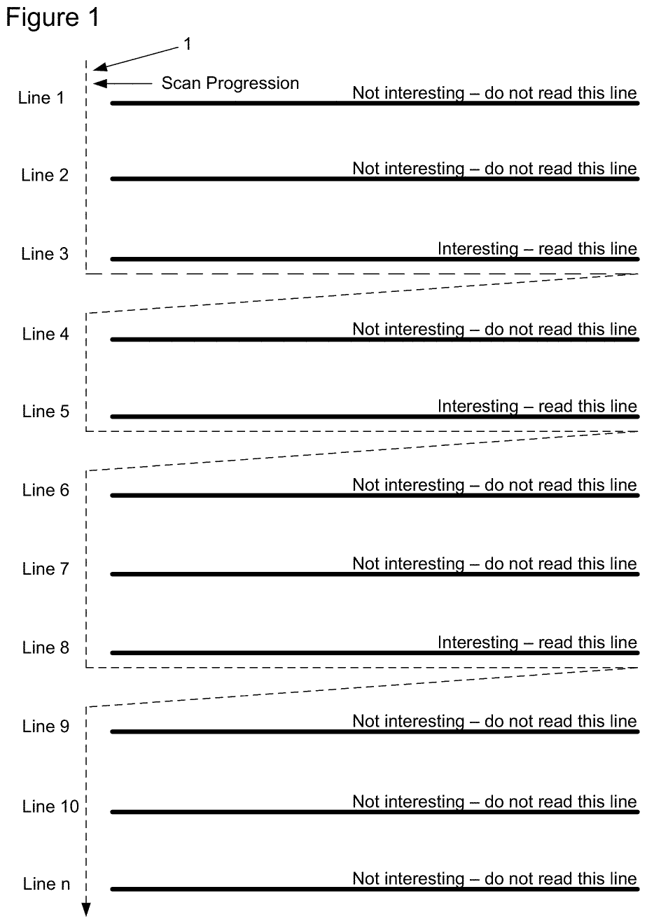

FIG. 1 illustrates the F-Pattern type of scanning a page. In this pattern, the reader scans down the left edges of the lines, as indicated by dashed line 1, for interesting key words and then stop and reads the line to the right when something interesting is found. Reading may continue to the next lines or if no additional information of interest is found, the reader will resume scanning the left line edges again in F-Pattern fashion.

Thus, the most effective use of the F-Pattern technique is to place the important information along the left side of a page.

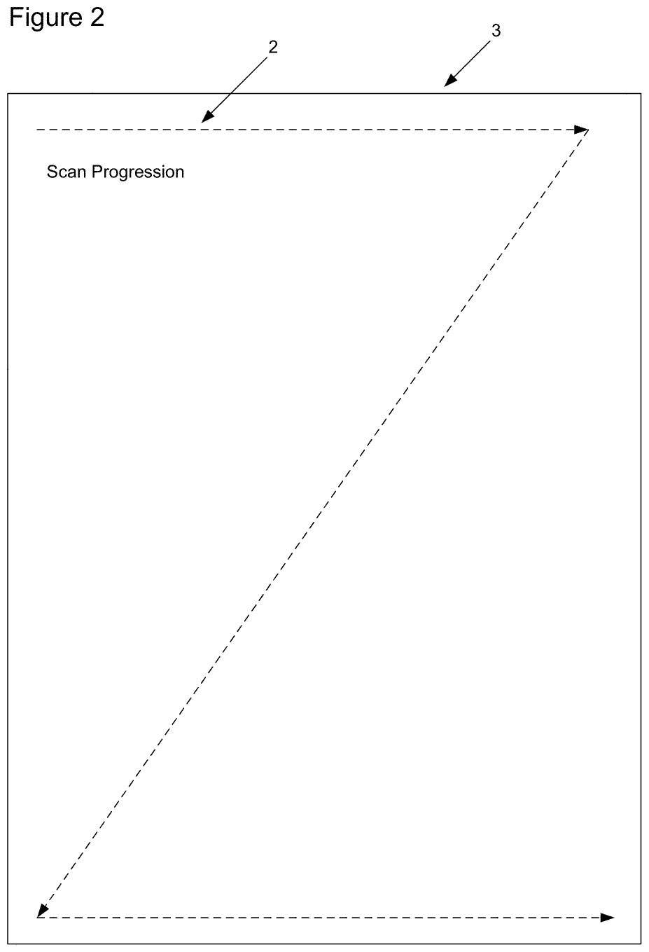

FIG. 2 illustrates the Z-Pattern type of scanning a page. In this scanning approach, the reader's eyes, as indicated by dashed line 2, begins by scanning across the top of, for example, page 3 where important information is likely to be found. The eyes then move directly to the opposite corner of the page and does the same thing across the bottom of the page.

The present invention is directed to a website that serves as a private marketplace for accredited investors and qualified institutional buyers to take long or short positions in individual commercial drugs, without investing in the company's manufacturing or distribution of the product. This illustration is by way of example only, the invention is not limited thereto.

In accordance with the invention, the user-facing features of the website, i.e. the pages of the website that a user sees and interacts with (HMI) are designed in such a manner that investors and buyers are present with information that follows the national eye scan patterns of humans where the most important information is located on the webpage where they are most likely to be viewed by the user. In some instances, an F-Pattern scan approach is used and in others a Z-Pattern scan approach is use. In other instances, a combination of the two approached are used.

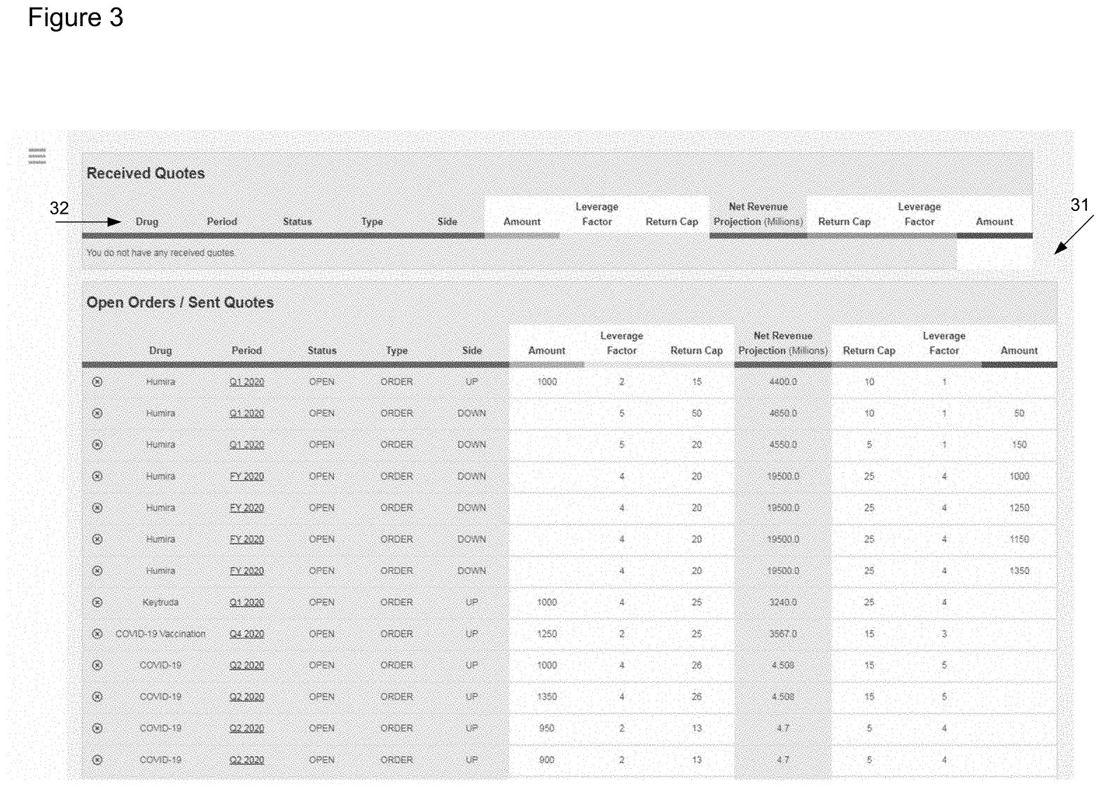

FIG. 3 is a screen shot of a representative page 31 of a website in accordance with the present invention. In this screen shot, drugs 32 are listed along the left edge of page 31 in F-Pattern style.

When a drug of interest is found, the view moves to the right and toward the center where the visual weight of the elements there define the importance of those elements and communicate to the user's eye what to focus on and in what order.

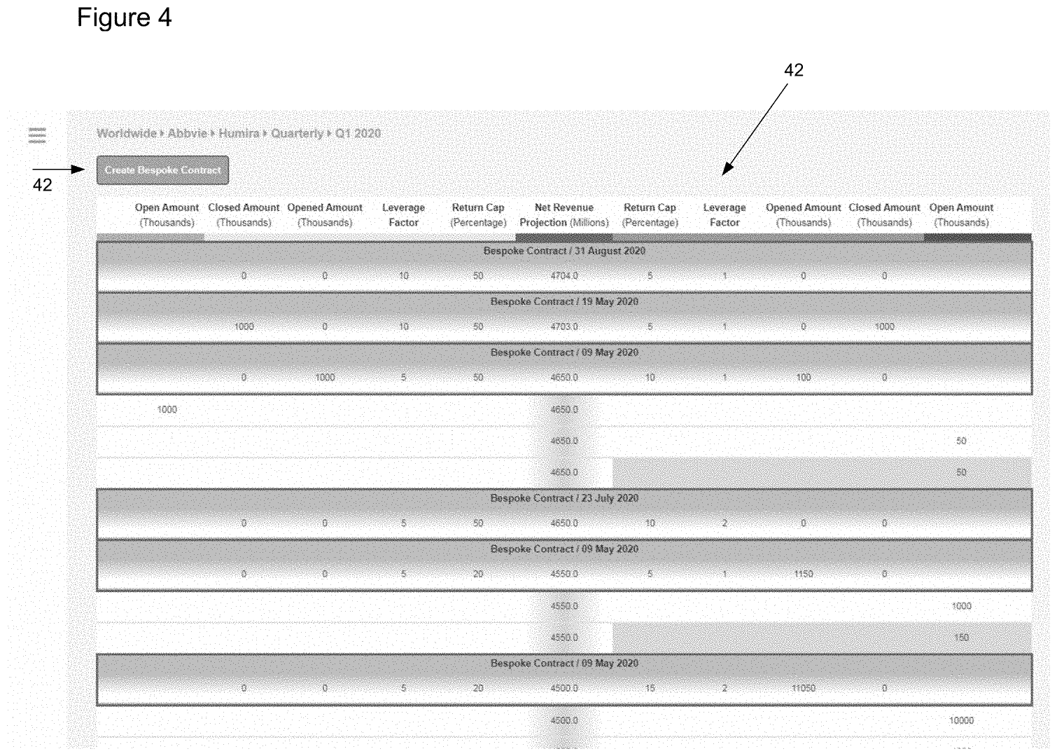

Once the user clicks on a drug of interest along the left-hand side of the screen shot shown in FIG. 3, a new webpage 41 is disclosed to the user as illustrated in FIG. 4. This page is where bespoke contracts can be made by the user clicking Create Bespoke Contact button 42 along the left side of the page

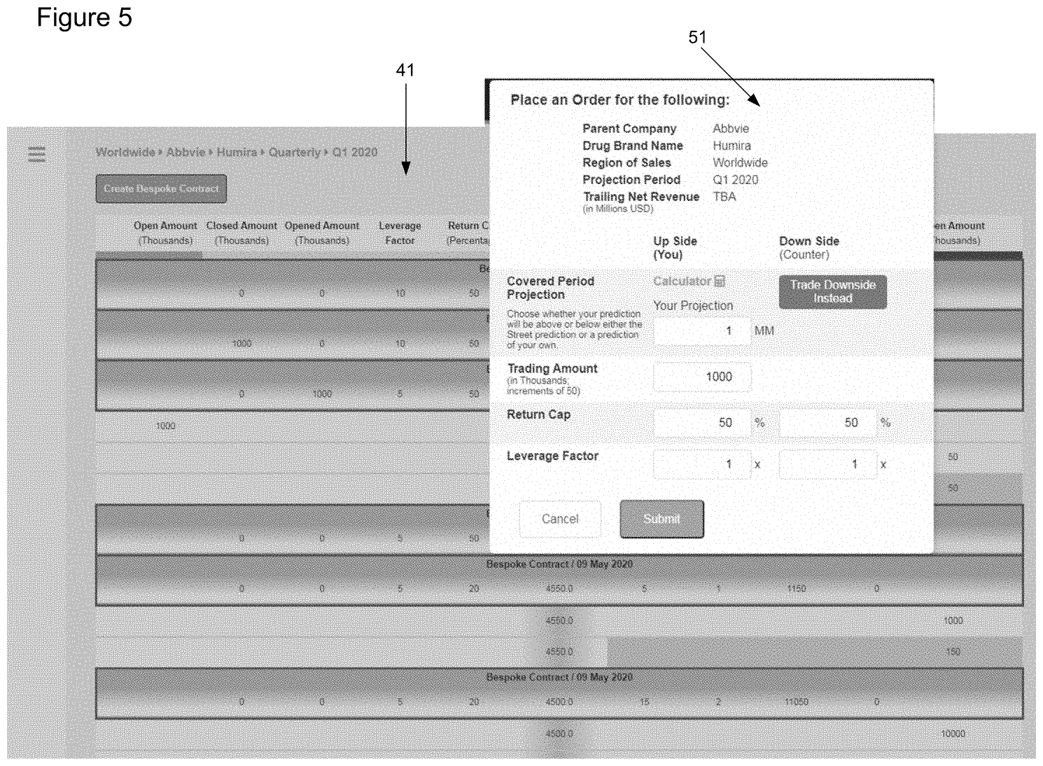

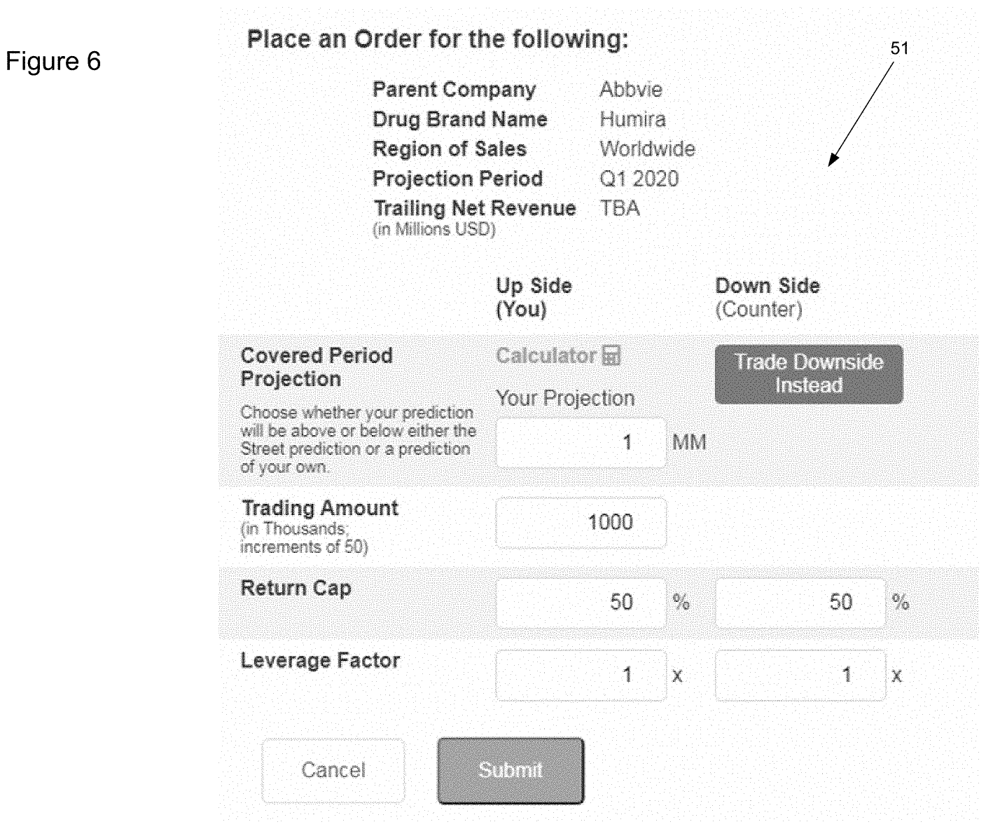

Clicking Create Bespoke Contact button 42 brings up an order dialog box 51 where the user can place an order for shares in the drug of interest. Note that as shown in FIG. 5, order dialog box 51 is automatically placed on top of and in the center of webpage 41. FIG. 6 is an enlarged view of the order dialog box 51 shown in FIG. 5.

As seen in FIG. 6, the visual weight of the dialog box 51, and the element that it contain, are such that it causes the user's eyes to focus in an orderly progression from top to bottom and from left to right of the dialog box 51.

Presenting the arrangement of elements and object in accordance with the present invention provides uses the ability to take a bullish or bearish position in a defined commercial pharmaceutical product (Humira, for example) without taking any exposure to the stock of the publicly traded parent (Abbvie, in the Humira example). The public reporting of the quarterly net sales of commercial healthcare assets (pharmaceutical products and divisions) will serve as the defining parameter of the settlement of contracts using the system of the invention. A position can be defined as net product sales within a defined region: Worldwide, United States, International, Emerging Markets, or other region resulting from the manner in which the webpages are laid out in accordance with the present invention.

The arrangement of elements on each page also allows users to navigate intuitively from page to page of the website in a manner that is consistent with the way in which the human eye focuses on a page.

While the foregoing specification teaches the principles of the present invention, with examples provided for the purpose of illustration, it will be appreciated by one skilled in the art from reading this disclosure that various changes in form and detail can be made without departing from the true scope of the invention.

I claim:

1. A method of presenting drug company information to potential investors on a computer display screen having a plurality of screen views, said method comprising the steps of:
listing a plurality of names of said drugs along the left edge of a first of said screen views in columnar format, wherein each of said names is a first clickable link to a corresponding second of said screen views;
listing in columnar format on said first screen view to the right of said names a plurality of columns of information corresponding to each respective one of said drugs names;
opening said second screen view when the respective one of said first clickable links is clicked to select a said drug of interest;
said second screen view presenting to the investor the opportunity to enter into a bespeak contract for said drug of interest in the form of a second clickable link;
said second clickable link opening a dialog box within said second screen view allowing the investor to enter a bespeak contract for said drug of interest.
